(19) United States
(12) Patent Application Publication
(10) Pub. No.: US 2017/0095131 A1
(43) Pub. Date: Apr. 6, 2017

(54) Cleaning Assembly

(71) Applicant: Larry Underwood, Bokeelia, FL (US)

(72) Inventor: Larry Underwood, Bokeelia, FL (US)

(21) Appl. No.: 14/874,631

(22) Filed: Oct. 5, 2015

(51) Int. Cl. A47L 13/12; B25G 1/10; A01D 34/416; A47L 11/282; A46B 13/02; A46B 15/00; H02K 7/14; A47L 11/14

(52) U.S. Cl. CPC A47L 13/12; H02K 7/145; B25G 1/102; A47L 11/14; A47L 11/282; A46B 13/02; A46B 15/00; A01D 34/4165

(57) ABSTRACT

A cleaning assembly includes a housing with an upper wall and a perimeter wall which is attached to and extends downwardly from the upper wall. A motor is mounted within the housing. An axle is attached to the motor and is accessible at a bottom side of the housing. The motor rotates the axle when the motor is turned on. A rod is elongated and has a first end and a second end. A handle is attached to the second end. A trigger is mounted on handle and the motor is turned on when the trigger is actuated. A plurality of heads is provided. Each of the heads includes an upper end and a lower end. Each of the upper ends comprises a coupler that releasably engages the axle. At least one of the heads is used for cleaning.

### BACKGROUND OF THE DISCLOSURE

### Field of the Disclosure

The disclosure relates to cleaning and trimming systems and more particularly pertains to a new cleaning and trimming system for providing a means to clean a floor surface while standing.

### SUMMARY OF THE DISCLOSURE

An embodiment of the disclosure meets the needs presented above by generally comprising a housing that includes an upper wall and a perimeter wall which is attached to and extends downwardly from the upper wall. A motor is mounted within the housing. An axle is attached to the motor and extends downwardly from the motor and is accessible at a bottom side of the housing. The motor rotates the axle when the motor is turned on. A rod is elongated and has a first end and a second end. The first end is attached to the housing and the rod has a length greater than 4.0 feet. A handle is attached to the second end. A trigger is mounted on handle and the motor is turned on when the trigger is actuated. A plurality of heads is provided. Each of the heads includes an upper end and a lower end. Each of the upper ends comprises a coupler that releasably engages the axle. At least one of the heads is used for cleaning.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a cleaning assembly according to an embodiment of the disclosure.

FIG. 2 is a side view of an embodiment of the disclosure.

FIG. 3 is a bottom view of an embodiment of the disclosure.

FIG. 4 is a cross-sectional view of an embodiment of the disclosure taken along line FIG. 1-1.

FIG. 5 is a perspective view of a plurality of heads of an embodiment of the disclosure.

### DESCRIPTION OF THE PREFERRED EMBODIMENT

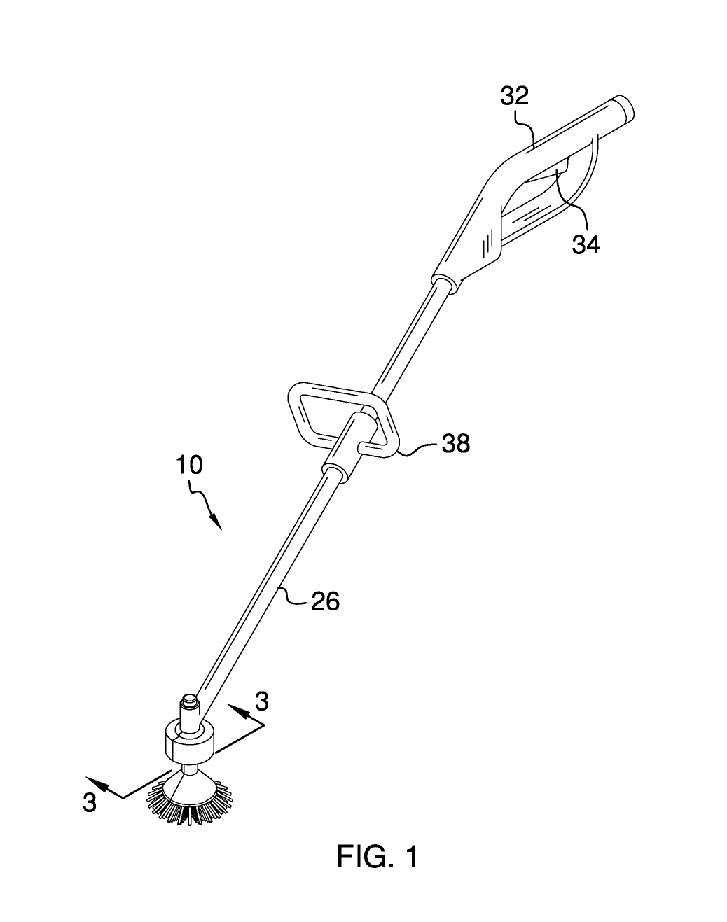

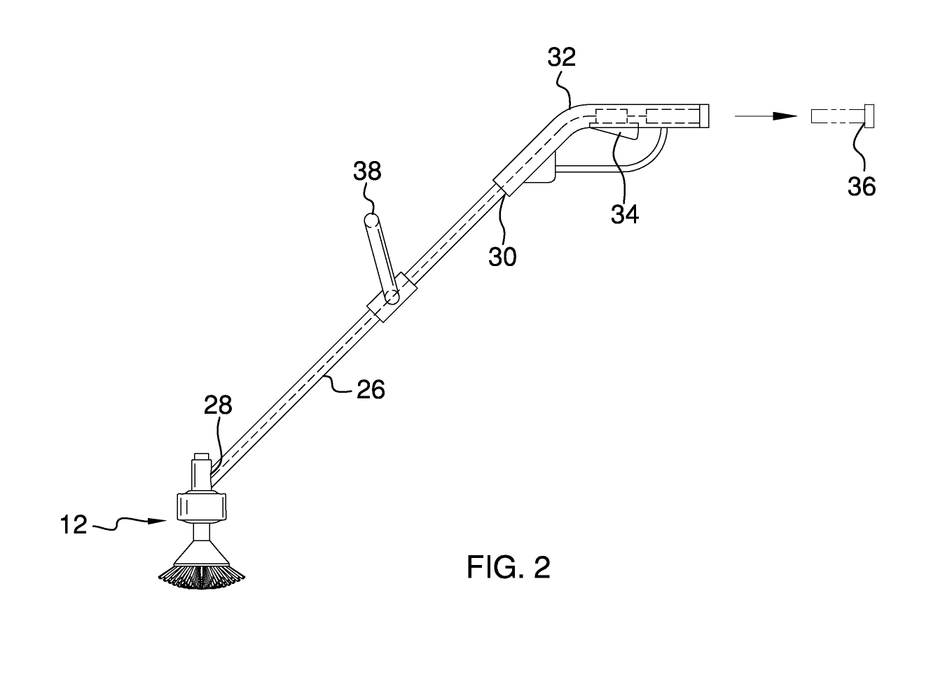

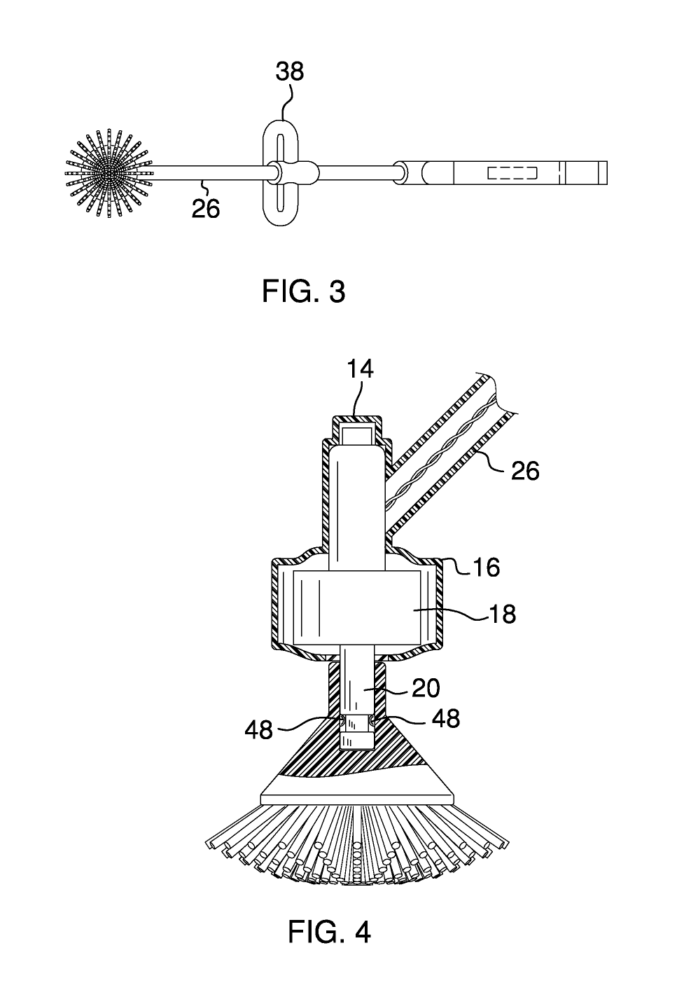

With reference now to the drawings, and in particular to FIGS. 1 through 5 thereof, a new cleaning and trimming system embodying the principles and concepts of an embodiment of the disclosure and generally designated by the reference numeral 10 will be described.

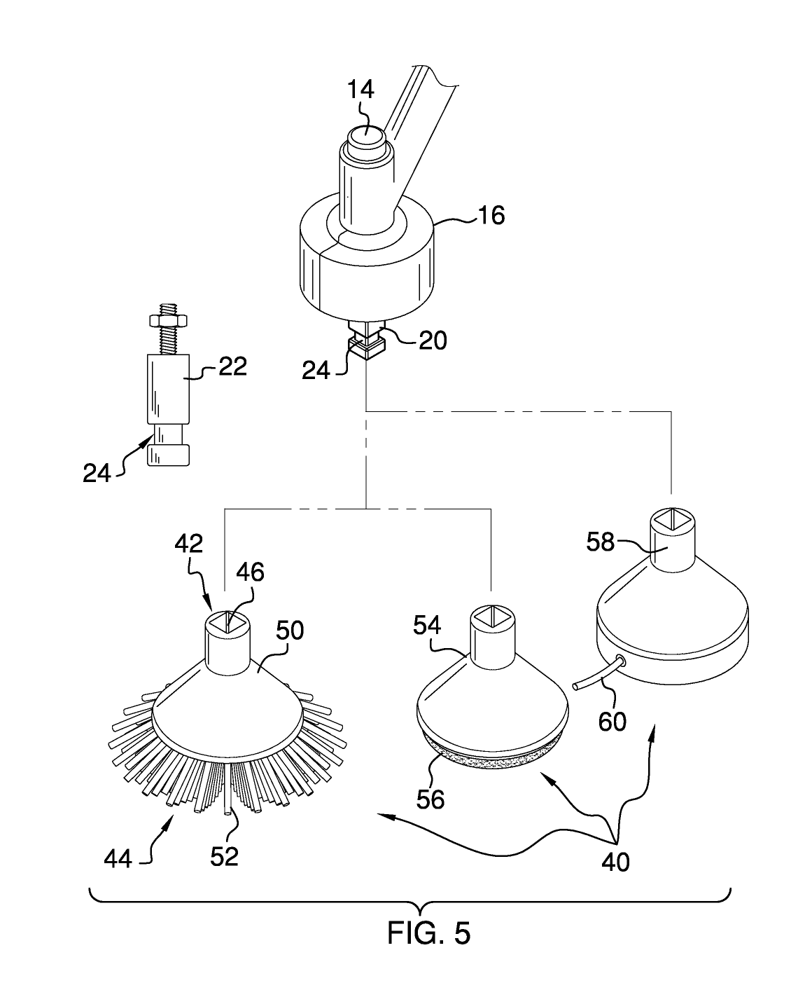

As best illustrated in FIGS. 1 through 5, the cleaning assembly 10 generally comprises a housing 12 that includes an upper wall 14 and a perimeter wall 16 which is attached to and extends downwardly from the upper wall 14. A motor 18 is mounted within the housing 12. An axle 20 is attached to the motor 18 and extends downwardly from the motor 18. The axle 20 is accessible at a bottom side of the housing 12. As can be seen in FIG. 5, an adaptor axle(s) 22 may be provided as needed depending upon the usage of the assembly 10. The motor 18 rotates the axle 22 when the motor 18 is turned on. The axle 22 may include a slot 24 therein for reasons described below.

A rod 26 is elongated and has a first end 28 and a second end 30. The first end 28 is attached to the housing 12 and the rod 26 has a length greater than 4.0 feet. The rod 26 extends upwardly and laterally from the housing 12 such that a line extending through the first 28 and second 30 ends forms an angle with an axis of rotation of the axle 20 between 120° and 160°. The rod 26 may include one or more bends for ergonomic purposes. A handle 32 is attached to the second end 30 and a trigger 34 is mounted on handle 32. The motor 18 is turned on when the trigger 34 is actuated. The motor 18 may comprise an electric motor powered by a rechargeable battery 36, though the motor 18 may comprise an internal combustion engine. A grip 38 may be attached to the rod 26 between the first 28 and second 30 ends. The above, generally including the housing 12, rod 26, axle 20 and means for rotating the axle 20, forms a structure conventional to weed trimming devices.

A plurality of heads 40 is provided which are selectively engageable with the axle 20. Each of the heads 40 includes an upper end 42 and a lower end 44. The upper ends 42 each comprises a coupler 46 that releasably engages the axle 20. The coupler 46 may include one or more detents 48 that extend into the slot 24 to releasably lock the selected head 40 to the axle 20. The plurality of heads 40 may include a first head 50 including a lower end 44 comprising a plurality of bristles 52. Different heads 40 having different types of bristles 52 may be provided. Thus the bristles 52 may be comprised of a cloth material if the surface to be cleaned is easily marred. A second head 54 may a lower end 44 comprising a scrubbing pad 56 or other scouring type surface. However, pads of soft material may also be provided such as for buffing and waxing purposes. A third head 58 may be used for yard cleaning projects and therefore including a cutting line 60, which may be made of plastic, configured for trimming grass.

In use, the assembly 10 may be used as a conventional weed trimmer. However, when a large surface requires cleaning, the proper head 40 may be used depending on the type of cleaning project to be undertaken. The rod 26 allows the user to stand while cleaning a surface while the motor 18 rotates the head 40 for efficient cleaning.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A work head driving assembly configured to receive and rotate a head, said assembly comprising:
a housing including an upper wall and a perimeter wall being attached to and extending downwardly from said upper wall;
a motor being mounted within said housing, an axle being attached to said motor and extending downwardly from said motor and being accessible at a bottom side of said housing, said motor rotating said axle when said motor is turned on, a portion of said axle extending from and exposed at said bottom side of said housing having a square cross-sectional shape perpendicular to a longitudinal axis of said axle;
a rod being elongated and having a first end and a second end, said first end being attached to said housing, said rod having a length greater than 4.0 feet;
a handle being attached to said second end;
a trigger being mounted on said handle, said motor being turned on when said trigger is actuated; and
a plurality of heads, each of said heads including an upper end and a lower end, each of said upper ends comprising a coupler complementary in shape to said axle, said coupler of each said head being releasably engageable to said axle such that rotation of said axle rotates said head, at least one of said heads being configured for cleaning.

2. The work head driving assembly according to claim 1, wherein said rod extends upwardly and laterally from said housing such that a line extending through said first and second ends forms an angle with an axis of rotation of said axle between 120° and 160°.

3. The work head driving assembly according to claim 1, wherein at least one of said heads is configured for trimming grass.

4. The work head driving assembly according to claim 1, wherein said plurality of heads including:
a first head including a lower end comprising a plurality of bristles;
a second head including a lower end comprising a scrubbing pad; and
a third head including a cutting line configured for trimming grass.

5. The work head driving assembly according to claim 1, wherein said plurality of heads including:
a first head including a lower end comprising a plurality of bristles; and
a second head including a lower end comprising a scrubbing pad.

6. A work head driving assembly configured to receive and rotate a head, said assembly comprising:
a housing including an upper wall and a perimeter wall being attached to and extending downwardly from said upper wall;
a motor being mounted within said housing, an axle being attached to said motor and extending downwardly from said motor and being accessible at a bottom side of said housing, a portion of said axle extending from and exposed at said bottom side of said housing having a square cross-sectional shape perpendicular to a longitudinal axis of said axle, said motor rotating said axle when said motor is turned on;
a rod being elongated and having a first end and a second end, said first end being attached to said housing, said rod having a length greater than 4.0 feet, said rod extending upwardly and laterally from said housing such that a line extending through said first and second ends forms an angle with an axis of rotation of said axle between 120° and 160°;
a handle being attached to said second end;
a trigger being mounted on said handle, said motor being turned on when said trigger is actuated;
a grip being attached to said rod between said first and second ends; and
a plurality of heads, each of said heads including an upper end and a lower end, each of said upper ends comprising a coupler complementary in shape to said axle, said coupler of each said head being releasably engageable to said axle such that rotation of said axle rotates said head, said plurality of heads including:
a first head including a lower end comprising a plurality of bristles;
a second head including a lower end comprising a scrubbing pad; and
a third head including a cutting line configured for trimming grass.
